(19) United States
(12) Patent Application Publication
(10) Pub. No.: US 2001/0034760 A1
(43) Pub. Date: Oct. 25, 2001

(54) Transaction terminal interface

(75) Inventor: Grant C. Paton, Dundee (GB)

Correspondence Address: Michael Chan, Intellectual Property Section, NCR Corporation, Law Department, 101 West Schantz, ECD-2, Dayton, OH, 45479-0001, US

(73) Assignee: NCR Corporation

(21) Appl. No.: 09/826,678

(22) Filed: Apr. 5, 2001

(30) Foreign Application Priority Data
Apr. 19, 2000 (GB) 0009567.9

(51) Int. Cl. G06F 17/60; G06F 15/16

(52) U.S. Cl. 709/203; 709/224

(57) ABSTRACT

An in-car device (30) is provided, for user interaction with a transaction terminal (32). The device (30) communicates with the terminal (32) via local transceivers (26, 34). Data or instructions may be entered to the device (30) by means of data entry devices (16), such as a keypad, and transmitted to the terminal (32) to be executed. Results of the instructions may be transmitted back, and displayed to the user on a display screen (12) provided on the device (30). The device (30) may be used to conduct financial transactions, such as charging a smart card with electronic cash, or may be used to purchase goods and/or services from a third party, via a network transceiver (40) provided in the terminal (32).

### BACKGROUND OF THE INVENTION

The present invention relates to an interface for use with a transaction terminal, such as an automated teller machine (ATM). The invention further relates to a method of interfacing with such a transaction terminal; and yet further to a transaction terminal capable of interfacing in such a manner.

Transaction terminals and self-service terminals (SSTs), such as automated teller machines (ATMs), are commonly used for performing many different types of transactions. Perhaps the most widespread use of transaction terminals is in financial transactions, such as managing a user's bank account; although numerous other non-financial or not solely financial transactions may also be conducted via specialized transaction terminals.

One feature of the expanding network of transaction terminals, and the increasing range of transactions operable therefrom, is the increasing variety of means by which transaction terminals may be accessed, beyond the “traditional” pedestrian accessible SSTs. One such alternative transaction terminal is the “drive-up” SST, which as the name suggests is intended for use by a user in a motor vehicle. This has numerous advantages in terms of ease of access and use for individuals who prefer to, or must, drive to access a transaction terminal.

However, despite the numerous benefits and advantages of drive up transaction terminals, there remain a number of aspects which may be of concern to a user. One of these is security: a typical drive-up transaction terminal, like a conventional SST, has a display monitor, card reader, and numeric keypad mounted on the fascia. However, with a drive-up transaction terminal, it is more difficult for a user to shield the display or keypad from onlookers, thereby raising the risk that confidential transactions and information, such as PINs or account balances, may be observed by others. Further, the comfort of users may be an issue. From a seated position in their vehicle, a user may have to twist and stretch in order to access the various features of the transaction terminal.

### SUMMARY OF THE INVENTION

It is among the objects of embodiments of the present invention to obviate or alleviate these and other disadvantages of existing transaction terminal interfaces. This is achieved, in part, by combining the convenience of drive-up transaction terminals with the increasing prevalence of in-car systems such as entertainment systems and the like.

As used herein, the term “in-car” is intended to relate to arrangements which are located permanently or semi-permanently within a vehicle. Such arrangements may be incorporated into the structure of a vehicle, for example in the dashboard fascia, or may be mounted separately on a part of the vehicle structure, for example supported on the dashboard surface. Furthermore, such arrangements may be removable from the vehicle, for reasons of security when the vehicle is not in use, although the arrangements are intended to remain in the vehicle while the vehicle is in use.

There is an ever-increasing level of technology being fitted as standard to modern motor vehicles. At the time of writing, in-car entertainment systems may include navigation systems, LCD displays, information services, and facilities for communication with remote locations. Such systems provide the opportunity to be adapted for use with transaction terminal interfaces, in accordance with aspects of the present invention.

According to a first aspect of the present invention, there is provided a method of conducting a transaction from within a vehicle, the method comprising the steps of:

locating the vehicle adjacent a transaction terminal;

entering user instructions on an in-car data entry facility provided within the vehicle; and

transmitting said user instructions locally to said terminal, the instructions being executed by said terminal.

The above method enables a user to interact with a self-service terminal (SST) or other transaction terminal comfortably while seated within their vehicle. As the user instructions are transmitted only over a short distance to the terminal (rather than via, for example, an existing wireless communications network) there is a relatively low risk of confidential data or instructions being intercepted or misdirected. Further, since the user is necessarily situated adjacent a particular known terminal, their location is also known, so reducing the risk of fraud.

Preferably, the method further comprises the step of identifying the user. This may be conducted by, for example, inserting an identification token such as a smart card into a reader mounted on the terminal; although more preferably the identification process may also be carried out at least partially within the vehicle. Thus the vehicle may itself contain a smart card reader or the like, and/or the user may enter a personal identification number (PIN) on the data entry facility, with the data so entered being transmitted to the terminal for confirmation of the user's identity. Various other identification means will be apparent to the skilled reader, for example, biometrics validation methods and the like.

An identification step is to be preferred in transactions where the user's identity is important; for example, those dealing with bank accounts or other financial transactions. However, where the user's identity is unimportant, for example, the method of the present invention is being used to order foodstuffs from a drive-through restaurant, then this step need not be included in the method of the invention.

Preferably, the method further includes the step of transmitting data locally from the terminal to the vehicle, and displaying a part of said data on an in-car display facility located within the vehicle. For example, once a transaction has been completed, the terminal may confirm this fact, and a suitable message displayed on a display screen within the vehicle. The data may include advertisements, suggestions for services available from the terminal, or the like. Alternatively, or in addition, the data may include responses to user requests or the results of transactions: for example, a user may request details of their account balance prior to withdrawing cash from the terminal. Numerous other examples of types of data which may be transmitted will readily occur to the skilled person.

The method of the present invention may also include one or more of the steps of:

retrieving cash or other valuable media dispensed from the terminal;

depositing cash or other valuable media into the terminal;

uploading electronic valuable media to a memory storage device located within the vehicle;

downloading electronic valuable media to the terminal from a memory storage device; and

moving the vehicle away from the terminal and collecting requested goods or services from a dispensing location.

These steps provide a range of uses to which the present invention may be put. Where the transaction involves electronic valuable media (for example, electronic cash) the memory storage device may comprise a random access memory (RAM) provided within the vehicle; or may comprise a “smart card”, which may further be provided in conjunction with an in-car smart card reader/writer within the vehicle. These electronic cash services may be utilized in order to charge a smart card with cash from a user's account, or to pay for goods/services, or to return unused credit to the user's account.

Preferably, the method yet further comprises the steps of transferring programs/instructions from the terminal to an in-car processor unit provided within the vehicle; and executing said programs/instructions. In a preferred embodiment these steps are performed subsequently to the step of locating the vehicle adjacent the transaction terminal. This enables each individual transaction terminal to provide the user with a user interface environment specific to the type of transactions offered, or to the user. In this way a user's vehicle interface unit may be pre-provided with only basic instructions relating to simple procedures, and yet would be able to handle transactions with a cash dispenser, a drive-through restaurant, and a vehicle maintenance depot, without requiring to be pre-configured by the user or the manufacturer.

According to a second aspect of the present invention, there is provided an in-car apparatus to be provided within a vehicle for user interfacing with a transaction terminal, the apparatus comprising means for interaction with a user, and means for transmitting data locally to a transaction terminal situated adjacent said apparatus.

Preferably, the interaction means comprises a data entry means and a display means. The two may be combined as a touch-sensitive display screen, or may be provided separately. A separate data-entry means may for example comprise a keypad, or a voice recognition module, or the like.

The local data transmission means may comprise a low-power radio transmitter, or an infra-red transmitter, or the like.

Preferably, the apparatus further comprises means for receiving data and/or instructions transmitted from a transaction terminal situated adjacent said apparatus. Preferably also the apparatus further comprises processing means for processing and executing data or instructions thus received.

Preferably the apparatus comprises memory storage means for recording data. The apparatus may alternatively or in addition include a removable storage medium reader/writer.

According to a third aspect of the present invention, there is provided a vehicle including an in-car apparatus for user interfacing with a transaction terminal, the apparatus comprising means for interaction with a user, and means for transmitting data locally to a transaction terminal situated adjacent said vehicle.

According to a fourth aspect of the present invention, there is provided a transaction terminal, the terminal comprising means for receiving data and/or instructions transmitted locally from a vehicle situated adjacent said terminal, and means for processing data and/or instructions thereby received.

### BRIEF DESCRIPTION OF THE DRAWINGS

These and other aspects of the present invention will now be described by way of example only and with reference to the accompanying Figures, in which:

FIG. 1 shows a sketch of an in-car apparatus to be provided within a vehicle for user interfacing with a transaction terminal, in accordance with one embodiment of the present invention; and

FIG. 2 is a schematic diagram of the components of the apparatus of FIG. 1 in combination with those of a transaction terminal, as may be used with the present invention.

### DETAILED DESCRIPTION

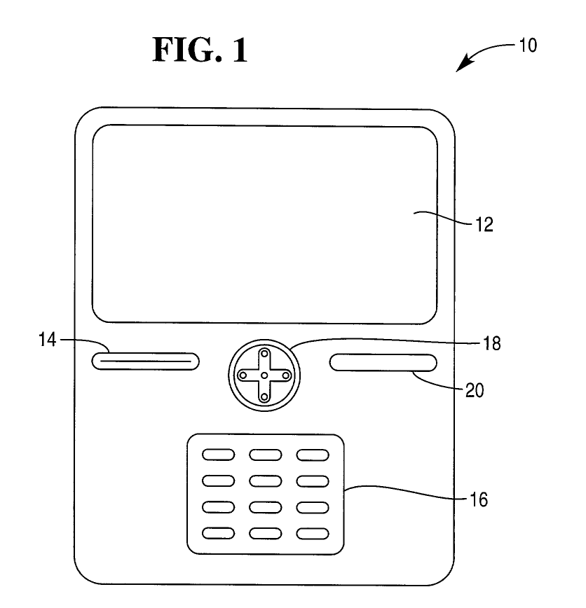

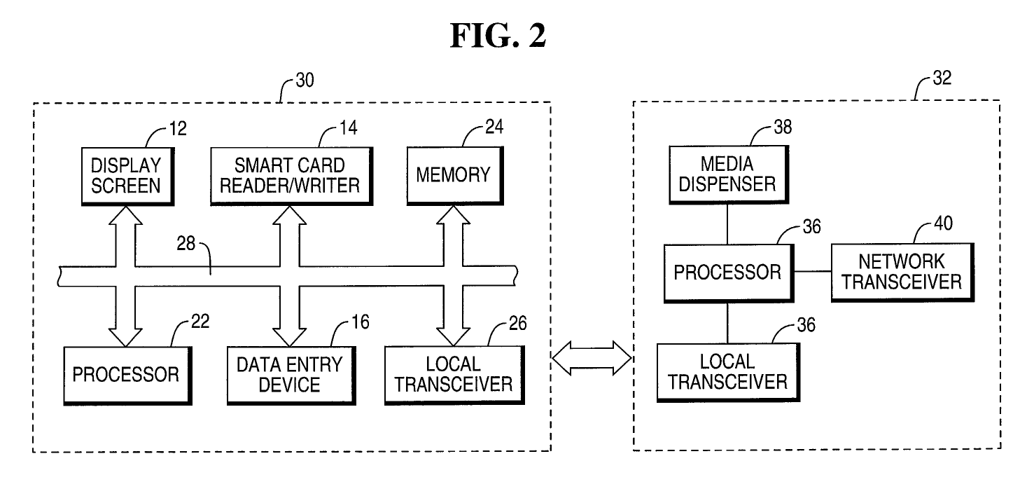

Referring first of all to FIG. 1, this shows the fascia of an in-car apparatus to be provided within a vehicle for conducting transactions, in accordance with one embodiment of the present invention. The fascia 10 is conveniently of a size and dimensions to be mounted beneath the dashboard of a vehicle on the central column, or other convenient location. Within the fascia 10 are mounted an LCD display screen 12, for displaying instructions and messages to a user; a smart card reader/writer 14; a numeric keypad 16 for data entry; and a navigation joypad 18 and selection button 20. This is only one possible embodiment of such an apparatus, and many different variants may be envisaged; for example, touch screen technology may be used instead of the keypad 16, joypad 18 and button 20; additional features may be incorporated within the fascia 10, and so forth. Numerous functional components of the apparatus are not shown in FIG. 1, as will become apparent on consideration of FIG. 2.

FIG. 2 shows schematically the components of the apparatus of FIG. 1, in conjunction with a transaction terminal as may form a part of the present invention.

The interface apparatus 30 (enclosed within a dashed-line box) includes a display screen 12, a smart card reader/writer 14, and data entry devices (keypad 16, joypad 18, and button 20), here represented only by the numeral 16, all as shown on FIG. 1. Also present within the apparatus 30 are a processing device 22, a memory store 24, and a local (that is, short range) transmitter/receiver 26, all of which components are connected in communication by a data bus 28.

Also shown on FIG. 2 is a transaction terminal 32, which comprises a second local transmitter/receiver 34, a second processor 36, a media dispenser 38, and a network transceiver 40.

The operation of the invention will now be described.

The user of the vehicle in which the interface 30 is mounted brings the vehicle into close proximity to a transaction terminal 32. The optimum location for the vehicle may be marked on the roadway by, for example, a box painted on the road, beneath which is located a component of the terminal transceiver 34 (for example, an induction loop).

On detection of the presence of a vehicle containing an active interface 30, the terminal processor 36 sends a signal via the terminal transceiver 34 to the interface transceiver 26 and processor 22. The interface sends an answering signal indicating it is ready to perform a transaction. A series of computer programs are then transferred from the terminal 32 to the memory 24 of the interface, where the processor 22 executes the programs to generate an appropriate interface environment for the particular transaction type.

The interface 30 prompts the user to insert their smart identification card into the smart card reader 14, and to enter an identification code using the keypad 16. This data is then transferred to the terminal 32, which indicates if it has accepted the user. The interface 30 then displays a series of context-sensitive menus on the display screen 22, and the user makes their desired choices of transactions via the data entry devices 16. The processor 22 then sends the appropriate instructions to the terminal 32.

The terminal processor 36 may then use a conventional network connection 40 to authorize the desired transaction (for example withdrawal of cash) with the central terminal operator. With this authorization received, a quantity of banknotes may be dispensed from media dispenser 38. The user then reaches from the vehicle to collect their cash, and drives away.

This describes only one possible transaction path. For example, rather than dispensing cash, electronic currency may be generated by the terminal 32, and transferred to the interface 30, where it may be stored on the user's smart card, or in the interface memory 24. A further alternative would be to use the interface 30 and terminal 32 to request a meal from a fast food restaurant. In this example the network connection 40 would communicate with a food server, who would then prepare the order to be collected by the user.

The person of skill in the art will doubtless be able to conceive of many other possible uses for the present invention. Numerous alterations and alternative embodiments will also be readily apparent: for example, the interface 30 may also be provided with a long-range transceiver, so the apparatus may interface with remote service providers, or be used as a mobile communication device. Alternative removable storage media may be provided, or even remote storage media, which do not require to be inserted into a reader but may instead be read at a distance by the interface.

It will however be clear that the present invention provides a simple, effective, secure, and comfortable means whereby a user may conduct a transaction at a transaction terminal from the comfort and safety of their own vehicle.

What is claimed is:

1. A method of conducting a transaction from within a vehicle, the method comprising the steps of:
locating the vehicle adjacent a transaction terminal;
entering user instructions on an in-car data entry facility provided within the vehicle; and
transmitting the user instructions locally to the terminal for execution by the terminal.

2. A method in accordance with claim 1, further comprising the step of identifying the user.

3. A method in accordance with claim 1, further including the steps of transmitting data locally from the terminal to the vehicle, and displaying a part of the data on an in-car display located within the vehicle.

4. A method in accordance with claim 1, further comprising the step of retrieving cash or other valuable media dispensed from the terminal.

5. A method in accordance with claim 1, further comprising the step of uploading electronic valuable media to a memory storage device located within the vehicle.

6. A method in accordance with claim 1, further comprising the step of downloading electronic valuable media to the terminal from a memory storage device.

7. A method in accordance with claim 1, further comprising the steps of transferring programs/instructions from the terminal to an in-car processor unit provided within the vehicle, and executing the programs/instructions.

8. An in-car apparatus to be provided within a vehicle for user interfacing with a transaction terminal, the apparatus comprising:
means for interacting with a user; and
means for transmitting data locally to a transaction terminal situated adjacent the apparatus.

9. An apparatus in accordance with claim 8, further comprising means for receiving data and/or instructions transmitted from a transaction terminal situated adjacent the apparatus.

10. An apparatus in accordance with claim 8, further comprising memory storage means for recording data.

11. A kit comprising:
a fascia including means for interacting with a user carrying out a transaction at a transaction terminal; and
means for mounting the fascia to at least a portion of a vehicle to provide an in-car apparatus for enabling a user in the vehicle to carry out a transaction at a transaction terminal located adjacent the vehicle.

12. A kit according to claim 11, wherein the mounting means includes means for mounting the fascia beneath the dashboard of the vehicle.

13. A kit in accordance with claim 11, further comprising means for transmitting data locally to the transaction terminal located adjacent the vehicle.

14. A kit in accordance with claim 11, further comprising means for receiving data and/or instructions transmitted from the transaction terminal located adjacent the vehicle.

15. A kit in accordance with claim 11, further comprising memory storage means for recording data.

16. A kit comprising:
a fascia including means for interacting with a user in a vehicle to allow the user to carry out a transaction at a transaction terminal located adjacent the vehicle; and
means for fixedly mounting the fascia to at least a portion of a vehicle.

17. A kit according to claim 16, wherein the mounting means includes means for fixedly mounting the fascia beneath the dashboard of the vehicle.

18. A kit in accordance with claim 16, further comprising means for transmitting data locally to the transaction terminal located adjacent the vehicle.

19. A kit in accordance with claim 16, further comprising means for receiving data and/or instructions transmitted from the transaction terminal located adjacent the vehicle.

20. A kit in accordance with claim 16, further comprising memory storage means for recording data.
